(19) United States
(12) Patent Application Publication
(10) Pub. No.: US 2014/0233893 A1
(43) Pub. Date: Aug. 21, 2014

(54) BACKWARDS COMPATIBLE MULTI-CORE FIBER OPTIC CABLE

(71) Applicant: CommScope, Inc. of North Carolina, Hickory, NC (US)

(72) Inventors: Richard Y. MEI, Parker, TX (US); Golam Mabud CHOUDHURY, Warren, NJ (US); Richard BACA, Allen, TX (US); Paul F. KOLESAR, McKinney, TX (US)

(73) Assignee: CommScope, Inc. of North Carolina, Hickory, NC (US)

(21) Appl. No.: 13/955,465

(22) Filed: Jul. 31, 2013

Related U.S. Application Data
(60) Provisional application No. 61/677,915, filed on Jul. 31, 2012.

(51) Int. Cl. G02B 6/38; G02B 6/02

(52) U.S. Cl. CPC G02B 6/3885; G02B 6/02042
USPC 385/76; 385/126

(57) ABSTRACT

A multi-core optical fiber has dimensions to be backwards compatible with a conventional, single-core optical fiber of the single-mode or multimode type. In one embodiment, the center core has a diameter, such as 3 to 9 um, 50 um or 62.5 um. Such a multi-core optical fiber can be used in connector envelopes like an LC, SC, ST or an array connector, such as an MTP/MPO connector, and will permit the fiber optic connector to continue supporting conventional transmission using only the central core of the optical fiber. Yet, allow fiber optic networks to be upgraded from supporting conventional transmission to parallel transmission using the multiple cores within the optical fiber at a later date.

This application claims the benefit of U.S. Provisional Application No. 61/677,915, filed Jul. 31, 2012.

### BACKGROUND OF THE INVENTION

1. Field of the Invention

The present invention relates to optical fiber and connecting hardware. More particularly, the present invention relates to a multi-core optical fiber with dimensions to be backwards compatible with a single-core optical fiber when the fiber centers are aligned.

2. Description of the Related Art

Multi-core optical fibers are known in the art. See for example, U.S. Pat. Nos. 5,734,773; 6,154,594 and U.S. Published Applications 2011/0229085; 2011/0229086 and 2011/0274398, each of which is herein incorporated by reference. Such multi-core optical fibers are terminated to connectors having separate channels or cores for each core of the multi-core optical fiber.

In the background of art U.S. Published Application 2011/0274398, as depicted in FIGS. 1 and 2, a multi-core optical fiber 180 typically has a center core 181 and multiple satellite cores 182 in a common cladding 184. The satellite cores 182 are positioned around the center core 181 symmetrically, at the vertices of a regular hexagon 183.

Each of the cores 181, 182 exhibits a same diameter. The center core 181 and each of the satellite cores 182 has a diameter of about 26 micrometers (um), depicted as distance A in FIG. 2. A center to center spacing relative to the adjacent satellite cores 182 is about 39 um, depicted as distance B in FIG. 2. Each of the cores 181, 182 carries a unique light signal, and each of the cores 181, 182 is terminated to a communications channel of a connector for communication of its unique signal to a device, or further cabling, at an opposite end of the connector.

Single-core optical fibers are known in the prior art, as well. FIG. 3 depicts a conventional, single-core optical fiber 11 having a centrally located core 13 of diameter C, which is approximately 62.5 um. The core 13 and surrounding cladding may together function as a multi-mode fiber.

FIG. 4 depicts a conventional, single-core optical fiber 21 having a centrally located core 23 of diameter D, which is approximately 50 um. The core 23 and surrounding cladding may together function as a multi-mode fiber.

FIG. 5 depicts a conventional, single-core optical fiber 31 having a centrally located core 33 of diameter E, which is a fixed diameter in the range of 3 to 9 um. The core 33 and surrounding cladding may together function as a single-mode fiber. For example, typical single mode fibers 31 transmitting wavelengths of about 850 nm have a core diameter E of about 3 um to about 5 um. Conventional single mode fibers 31 transmitting wavelengths of about 1310 nm have a core diameter E of about 8 um to about 9 um.

### SUMMARY OF THE INVENTION

The Applicants have invented a multi-core optical fiber with dimensions to be backwards compatible with a conventional, single-core optical fiber of the single-mode or multimode type. Such an optical fiber will allow fiber optic networks to be upgraded from supporting conventional transmission using the central core of the fiber strand to parallel transmission using space-division multiplexing via multiple cores within the fiber strand.

Applicants have appreciated that some customers may desire to upgrade the fiber optic cabling to multi-core cabling, but not yet be ready to purchase upgraded equipment that utilizes multi-core ports. Hence, the customer would like to continue to use existing equipment with single core ports for accepting single core fibers, but yet invest in multi-core fiber optic cables in order to take a step toward future expansion/enhancement of the overall system.

The Applicants have invented a multi-core optical fiber which is backwards compatible to existing conventional single core optical fibers and associated connectors. The peripheral or satellite cores of the multi-core optical fiber would be “dark,” e.g., unused, when the multi-core optical fiber is terminated to a conventional single core system.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is an end view of a multi-core optical fiber in accordance with the prior art;

FIG. 2 is an end view of the multi-core optical fiber of FIG. 1, showing the dimension and spacings of the cores in accordance with the prior art;

FIG. 3 is a perspective view of an end of a single-core optical fiber, in accordance with a first embodiment of the prior art;

FIG. 4 is a perspective view of an end of a single-core optical fiber, in accordance with a second embodiment of the prior art;

FIG. 5 is a perspective view of an end of a single-core optical fiber, in accordance with a third embodiment of the prior art;

FIG. 6 is a perspective view of an end of a multi-core optical fiber, in accordance with a first embodiment of the present invention;

FIG. 7 is a perspective view of an end of a multi-core optical fiber, in accordance with a second embodiment of the present invention;

FIG. 8 is a perspective view of an end of a multi-core optical fiber, in accordance with a third embodiment of the present invention;

FIG. 9 is a perspective view of an end of a multi-core optical fiber, in accordance with a fourth embodiment of the present invention;

FIG. 10 is a perspective view of an LC fiber optic connector, in accordance with the present invention, holding one of the multi-core optical fibers of FIGS. 6-9; and

FIG. 11 is a perspective view of an MTP/MPO fiber optic connector, in accordance with the present invention, holding one or more of the multi-core optical fibers of FIGS. 6-9.

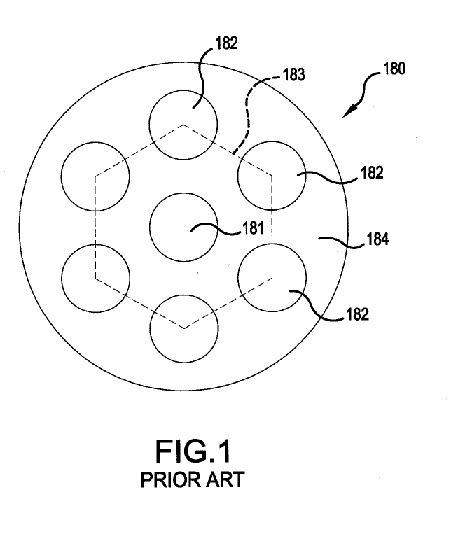

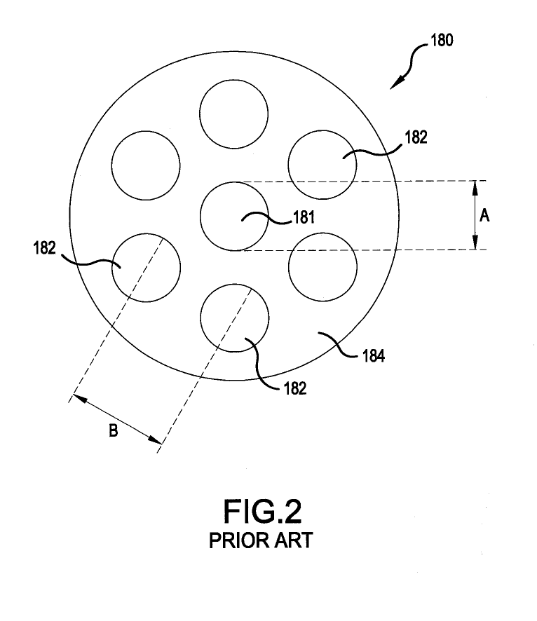

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

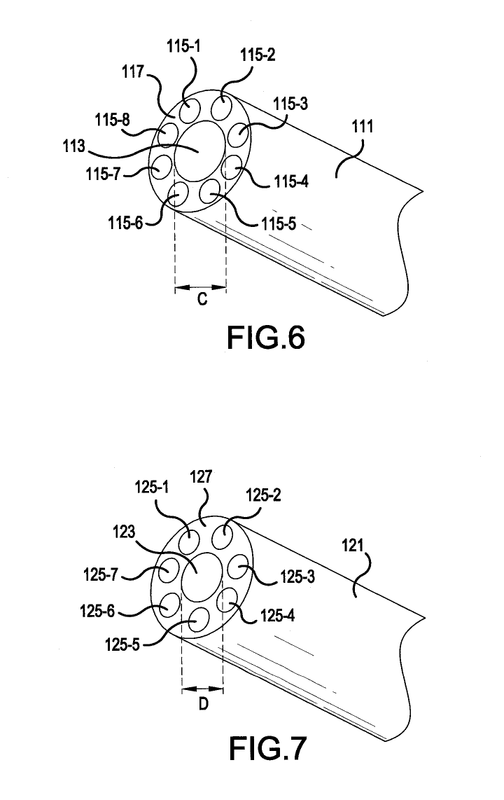

FIG. 6 is a perspective view of an end of a multi-core optical fiber 111, in accordance with a first embodiment of the present invention. A first optical core 113 is centrally located and has a diameter C of about 62.5 um. Eight other satellite optical cores 115-1, 115-2, 115-3, 115-4, 115-5, 115-6, 115-7 and 115-8 are located symmetrically around a periphery of the first optical core 113, with all of the optical cores 113, 115-1, 115-2, 115-3, 115-4, 115-5, 115-6, 115-7 and 115-8 being surrounded by cladding 117. Each of the satellite optical cores 115-1, 115-2, 115-3, 115-4, 115-5, 115-6, 115-7 and 115-8 has a diameter of about 25 um. Further, a center-to-center spacing of about 39 um exists between adjacent satellite optical cores 115-1, 115-2, 115-3, 115-4, 115-5, 115-6, 115-7 and 115-8. Although eight satellite optical cores 115-1, 115-2, 115-3, 115-4, 115-5, 115-6, 115-7 and 115-8 are shown, it should be appreciated that more or fewer satellite optical cores could be arranged around the first optical core 113, such as four, five, six, seven, nine or ten. Also, the arrangement need not be symmetrical.

The centrally located, first optical core 113 has the same diameter C as the conventional single core 13 of multi-mode fiber 11 in the prior art depicted in FIG. 3, namely 62.5 um. Hence, the multi-core optical fiber 111 of the present invention may be connected to a conventional single core fiber 11 by aligning the centers of the optical cores 113 and 13. Such a system would use only the centrally located, first optical core 113 for transmission, while the peripherally located satellite optical cores 115-1, 115-2, 115-3, 115-4, 115-5, 115-6, 115-7 and 115-8 remain dark or unused, e.g., persevered for future use when the multi-core fiber 111 is terminated to a multi-channel device, during a system upgrade at a later date.

FIG. 7 is a perspective view of an end of a multi-core optical fiber 121, in accordance with a second embodiment of the present invention. A first optical core 123 is centrally located and has a diameter D of about 50 um. Seven other satellite optical cores 125-1, 125-2, 125-3, 125-4, 125-5, 125-6 and 125-7 are located symmetrically around a periphery of the first optical core 123, with all of the optical cores 123, 125-1, 125-2, 125-3, 125-4, 125-5, 125-6 and 125-7 being surrounded by cladding 127. Each of the satellite optical cores 125-1, 125-2, 125-3, 125-4, 125-5, 125-6 and 125-7 has a diameter of about 25 um. Further, a center-to-center spacing of about 39 um exists between adjacent satellite optical cores 125-1, 125-2, 125-3, 125-4, 125-5, 125-6 and 125-7. Although seven satellite optical cores 125-1, 125-2, 125-3, 125-4, 125-5, 125-6 and 125-7 are shown, it should be appreciated that more or fewer satellite optical cores could be arranged around the first optical core 123, such as four, five, six, eight, nine or ten. Also, the arrangement need not be symmetrical.

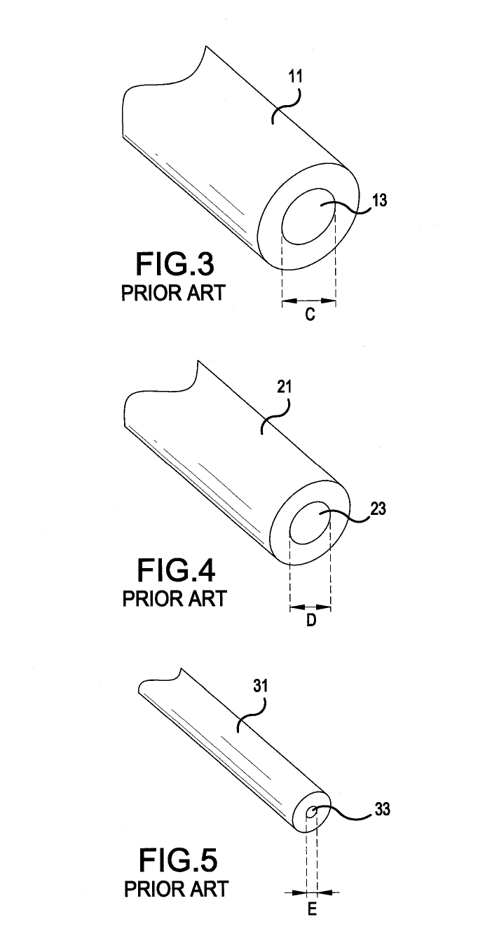

The centrally located, first optical core 123 has the same diameter D as the conventional single core 23 of multi-mode fiber 21 in the prior art depicted in FIG. 4, namely 50 um. Hence, the multi-core optical fiber 121 of the present invention may be connected to a conventional single core fiber 21 by aligning the centers of the optical cores 123 and 23. Such a system would use only the centrally located, first optical core 123 for transmission, while the peripherally located satellite optical cores 125-1, 125-2, 125-3, 125-4, 125-5, 125-6 and 125-7 remain dark or unused, e.g., persevered for future use when the multi-core fiber 121 is terminated to a multi-channel device, during a system upgrade at a later date.

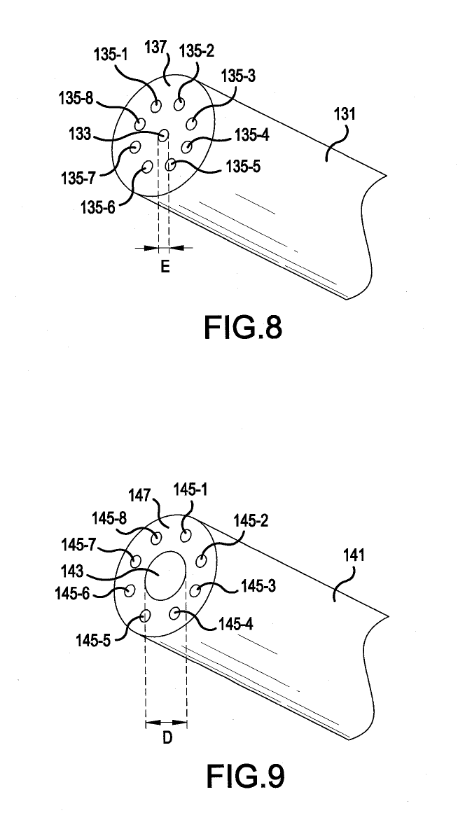

FIG. 8 is a perspective view of an end of a multi-core optical fiber 131, in accordance with a third embodiment of the present invention. A first optical core 133 is centrally located and has a fixed diameter E of about 3 to 9 um. Eight other satellite optical cores 135-1, 135-2, 135-3, 135-4, 135-5, 135-6, 135-7 and 135-8 are located symmetrically around a periphery of the first optical core 133, with all of the optical cores 133, 135-1, 135-2, 135-3, 135-4, 135-5, 135-6, 135-7 and 135-8 being surrounded by cladding 137. Each of the satellite optical cores 135-1, 135-2, 135-3, 135-4, 135-5, 135-6, 135-7 and 135-8 has a diameter similar to the first optical core 133, e.g., a fixed diameter of about 3 to 9 um. Further, a center-to-center spacing of about 30 to 39 um exists between adjacent satellite optical cores 135-1, 135-2, 135-3, 135-4, 135-5, 135-6, 135-7 and 135-8. Although eight satellite optical cores 135-1, 135-2, 135-3, 135-4, 135-5, 135-6, 135-7 and 135-8 are shown, it should be appreciated that more or fewer satellite optical cores could be arranged around the first optical core 133, such as four, five, six, seven, nine or ten. Also, the arrangement need not be symmetrical.

The centrally located, first optical core 133 has the same, matching diameter E as the conventional single core 33 of single-mode fiber 31 in the prior art depicted in FIG. 5, namely a fixed diameter of about 3 to 9 um. Hence, the multi-core optical fiber 131 of the present invention may be connected to a conventional single core fiber 31 by aligning the centers of the optical cores 133 and 33. Such a system would use only the centrally located, first optical core 133 for transmission, while the peripherally located satellite optical cores 135-1, 135-2, 135-3, 135-4, 135-5, 135-6, 135-7 and 135-8 remain dark or unused, e.g., persevered for future use when the multi-core fiber 131 is terminated to a multi-channel device, during a system upgrade at a later date.

FIG. 9 is a perspective view of an end of a multi-core optical fiber 141, in accordance with a fourth embodiment of the present invention. A first optical core 143 is centrally located and has a fixed diameter D of about 50 um. Eight other satellite optical cores 145-1, 145-2, 145-3, 145-4, 145-5, 145-6, 145-7 and 145-8 are located symmetrically around a periphery of the first optical core 143, with all of the optical cores 143, 145-1, 145-2, 145-3, 145-4, 145-5, 145-6, 145-7 and 145-8 being surrounded by cladding 147. Each of the satellite optical cores 145-1, 145-2, 145-3, 145-4, 145-5, 145-6, 145-7 and 145-8 has a diameter similar to a conventional single-mode optical fiber, e.g., a fixed diameter of about 3 to 9 um. Further, a center-to-center spacing of about 39 um exists between adjacent satellite optical cores 145-1, 145-2, 145-3, 145-4, 145-5, 145-6, 145-7 and 145-8. Although eight satellite optical cores 145-1, 145-2, 145-3, 145-4, 145-5, 145-6, 145-7 and 145-8 are shown, it should be appreciated that more or fewer satellite optical cores could be arranged around the first optical core 143, such as four, five, six, seven, nine or ten. Also, the arrangement need not be symmetrical.

The centrally located, first optical core 143 has the same, matching diameter D as the conventional single core 23 of multi-mode fiber 21 in the prior art depicted in FIG. 4, namely about 50 um. Hence, the multi-core optical fiber 141 of the present invention may be connected to a conventional single core fiber 21 by aligning the centers of the optical cores 143 and 23. Such a system would use only the centrally located, first optical core 143 for transmission, while the peripherally located satellite optical cores 145-1, 145-2, 145-3, 145-4, 145-5, 145-6, 145-7 and 145-8 remain dark or unused, e.g., persevered for future use when the multi-core fiber 141 is terminated to a multi-channel device, during a system upgrade at a later date.

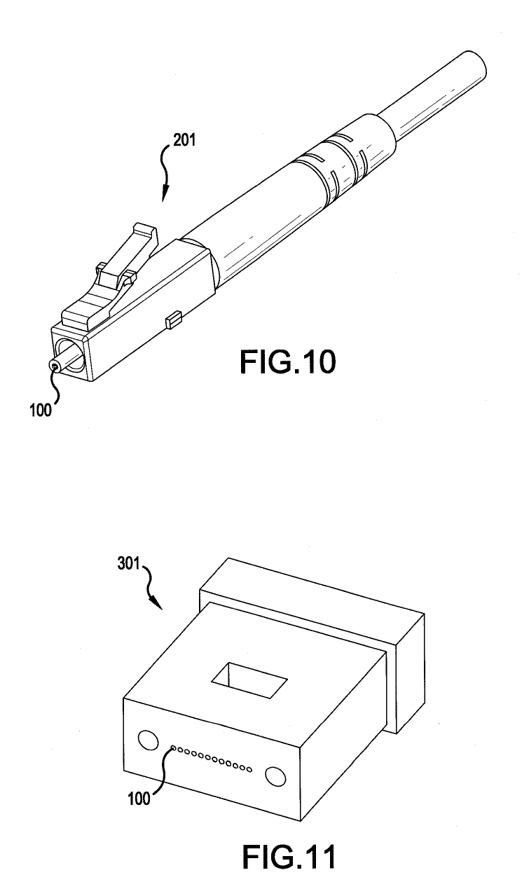

FIG. 10 depicts a single channel connector, such as an LC connector 201. The LC connector 201 is attached to one of the multi-core optical fibers 111, 121, 131 or 141 and presents an end 100 of the multi-core optical fiber 111, 121, 131 or 141 for connection to a port of a device. The alignment is such within the LC connector 201 that the first optical core 113, 123, 133 or 143 will axially align with the single core 13, 23, 33 or 23, respectively, of a conventional single core fiber 11, 21, 31 or 22, respectively, in the port of the device.

FIG. 11 depicts an array connector, such as an MTP/MPO connector 301. The MTP/MPO connector 301 is attached to at least one of the multi-core optical fibers 111, 121, 131 or 141 and presents an end 100 of the multi-core optical fiber 111, 121, 131 or 141 for connection to a port of a device. The alignment is such within the MTP/MPO connector 301 that the first optical core 113, 123, 133 or 143 will axially align with the single core 13, 23, 33 or 23, respectively, of a conventional single core fiber 11, 21, 31 or 21, respectively, in the port of the device.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A device comprising:
a centrally located first optical core;
a plurality of other optical cores located around a periphery of said first optical core; and
a cladding surrounding said first optical core and said plurality of other optical cores to form a multi-core optical fiber, wherein said first optical core has a diameter corresponding to a core diameter of a conventional single core optical fiber.

2. The device of claim 1, wherein said diameter of said first optical core is about 50 um.

3. The device of claim 1, wherein said diameter of said first optical core is about 62.5 um.

4. The device of claim 1, wherein said diameter of said first optical core is a fixed value in the range of about 3 um to about 9 um.

5. The device of claim 1, wherein said plurality of other optical cores includes at least four optical cores symmetrically disposed around said first optical core.

6. The device of claim 1, wherein said plurality of other optical cores includes at least six optical cores symmetrically disposed around said first optical core.

7. The device of claim 1, wherein said plurality of other optical cores each have a diameter of about 25 um.

8. The device of claim 1, wherein said plurality of other optical cores each have a diameter of a fixed value in the range of about 3 um to about 9 um.

9. The device of claim 1, further comprising:
a single channel connector attached to said multi-core optical fiber, wherein said first optical core will axially align with the core of a conventional single core fiber when said single channel connector is mated to a conventional single core fiber, and wherein said plurality of other optical cores are unused.

10. The device of claim 9, wherein said first optical core is a multimode optical core.

11. The device of claim 9, wherein said first optical core is a single-mode optical core.

12. The device of claim 9, wherein said connector is an LC, SC or ST connector.

13. The device of claim 1, further comprising:
an array connector attached to said multi-core optical fiber, wherein said first optical core will axially align with the core of a conventional single core fiber when a channel of said array connector having said multi-core optical fiber is mated to a conventional single core fiber, and wherein said plurality of other optical cores are unused.

14. The device of claim 13, wherein said array connector is an MTP/MPO connector.

15. A device comprising:
a first optical core;
a plurality of other optical cores located around a periphery of said first optical core; and
a cladding surrounding said first optical core and said plurality of other optical cores to form a multi-core optical fiber, wherein said first optical core has a diameter of 50 um, 62.5 um or a fixed value in the range of about 3 um to about 9 um.

16. The device of claim 15, wherein said plurality of other optical cores includes at least four satellite optical cores symmetrically disposed around said first optical core, and wherein said first optical core is centrally located within said multi-core optical fiber.

17. The device of claim 16, wherein said at least four satellite optical cores each have a diameter of about 25 um or each have a diameter of a fixed value in the range of about 3 um to about 9 um.

18. The device of claim 16, further comprising:
a single channel connector attached to said multi-core optical fiber, wherein said first optical core will axially align with the core of a conventional single core fiber when said single channel connector is mated to a conventional single core fiber, and wherein said plurality of other optical cores are unused.

19. The device of claim 16, further comprising:
an array connector attached to said multi-core optical fiber, wherein said first optical core will axially align with the core of a conventional single core fiber when a channel of said array connector having said multi-core optical fiber is mated to a conventional single core fiber, and wherein said plurality of other optical cores are unused.

20. A device comprising:
a centrally located first optical core;
a plurality of other optical cores located around a periphery of said first optical core; and
a cladding surrounding said first optical core and said plurality of other optical cores to form a multi-core optical fiber; and
a connector attached to said multi-core optical fiber, wherein said first optical core will axially align with a core of a single core fiber when said connector is mated to a port presenting the single core fiber.
